(19) United States
(12) Patent Application Publication
(10) Pub. No.: US 2011/0250998 A1
(43) Pub. Date: Oct. 13, 2011

(54) Pulley Support Structure for Belt-Drive Continuously Variable Transmission and Belt-Drive Continuously Variable Transmission

(75) Inventors: Shigeki Hizuka, Fujisawa-shi (JP); Kouji Ueda, Fujisawa-shi (JP); Susumu Tanaka, Fujisawa-shi (JP); Nobuaki Mitamura, Fujisawa-shi (JP)

(73) Assignee: NSK Ltd., Shinagawa-ku, Tokyo (JP)

(21) Appl. No.: 13/058,686

(22) PCT Filed: Dec. 28, 2009
(86) PCT No.: PCT/JP2009/071793

§ 371 Date: Feb. 11, 2011

(30) Foreign Application Priority Data
Dec. 26, 2008 (JP) 2008-334399

(51) Int. Cl. F16C 33/58; F16H 55/56

(52) U.S. Cl. 474/8; 384/569

(57) ABSTRACT

A pulley support structure for a belt-drive continuously variable transmission and a belt-drive continuously variable transmission are provided that are able to control the occurrence of Mindlin slip itself, and in cases where Mindlin slip has occurred, are able to effectively reduce the effects thereof. In this pulley support structure for a belt-drive continuously variable transmission, 2500 MPs or less is the maximum contact pressure during use between the raceway surfaces of the inner wheel and outer wheel and the rolling elements in the various roller bearings for rotatably supporting the pulleys for the continuously variable transmission. The rolling element surface hardness is HRc 60 or greater, and is at least 1 HRc harder than that of the raceway surfaces. The surface of the rolling element is nitrided or carbonitrided, and the nitrogen concentration in the surface is 0.2% by mass or greater and 2.0% by mass or less. Radial direction gap in the various roller bearings during use is −30 μm or greater and 10 μm or less.

### TECHNICAL FIELD

The present invention relates to a belt-drive continuously variable transmission used as a transmission unit for an automatic transmission of, for example, a motorcar, more particularly to a pulley support structure in a rotating section, which rotatably supports a pulley for a stepless transmission of a belt-drive continuously variable transmission.

### BACKGROUND ART

This type of belt-drive continuously variable transmission has been proposed for example in Patent Documents 1 to 3, and some transmission thereof has been put into practical use.

This type of belt-drive continuously variable transmission includes a transmission case, which is a stationary section, and a rotating section, which rotatably supports a pulley for the stepless transmission to this transmission case.

The rotating section has an input side rotating shaft and an output side rotating shaft arranged in parallel with each other. The input side rotating shaft is supported via a pair of rolling bearings to a transmission case. A driving side pulley, which rotates in synchronization with the input side rotating shaft itself and has a groove of which width is expandable and contractable, is disposed at a position between the pair of rolling bearings.

On the other hand, the output side rotating shaft is supported via another pair of rolling bearings to the transmission case, and a driven side pulley, which rotates in synchronization with the output side rotating shaft and has a groove of which width is expandable and contractable, is disposed at a position between the other pair of rolling bearings. An endless belt is laid over the driving side pulley and the driven side pulley. When a transmission ratio between the input side rotating shaft and the output side rotating shaft is changed, the shape is made by expanding or contracting the groove widths of the driving side pulley and the driven side pulley while correlating the groove widths of the driving side pulley and the driven side pulley.

The input side rotating shaft is rotated via a torque converter or a start clutch (e.g., electromagnetic clutch) by a drive source such as an engine. The power transmitted from the drive source to the input side rotating shaft via the start clutch is then transmitted from the driving side pulley to the driven side pulley via an endless belt. The power transmitted to the driven side pulley is then transmitted from the output side rotating shaft to driving wheels via a speed reducing gear train, a differential gear etc.

### PRIOR ART DOCUMENTS

### Patent Documents

Patent Document 1: JP Utility Model Laid-open No. JP 8-30526B
Patent Document 2: JP Laid-open No. 2004-183765 A
Patent Document 3: JP Laid-open No. 2008-267509 A
Patent Document 4: JP Laid-open No. 2009-41744 A

### DISCLOSURE OF THE INVENTION

### Problem to be Solved by the Invention

In the pulley support structure of this type of belt-drive continuously variable transmission, the rolling bearings, which support, for example, the input side rotating shaft and the output side rotating shaft, is subjected to a load from belt tension of the endless belt even while it is stopped. Therefore, a vibration transmitted from an engine etc. in that state may cause fretting (Mindlin slip) between a rolling element and a race.

Generally, Mindlin slip causes when a very minute area is subjected to repeated load changes. Radial repetitive small oscillations or changes in load (radial direction) may break an oil film of a contact section, or more specifically as minute adhesion and flaking repeat in bearings in the state of the rolling element surface and the raceway surface having a metal-to-metal contact with each other, damage to the surface is caused and developed. Rotation of bearings causes the damaged rolling element due to the Mindlin slip to rotate, resulting in damage such as flaking etc.

When a Mindlin slip occurs between the rolling element and a race, roughness of the rolling contact surface and the raceway surface on which the Mindlin slip has occurred deteriorates. If the surface shape of the rolling element particularly deteriorates, a tangential force exerted between the rolling element and the race will become larger, thereby shortening the life of the race. Therefore, in order to attain a further extended life of the belt-drive continuously variable transmission, it is important to suppress deterioration of the surface roughness due to the Mindlin slip occurred in the rolling bearing, which supports the input side rotating shaft and the output side rotating shaft in the pulley support structure.

General approaches to reduce damage due to Mindlin slip include: a method of reducing the so-called similar component metals phenomenon by changing the material to be contacted to ceramics etc. and thereby reducing minute adhesion in the case where an oil film is broken, a method of using a low viscosity lubricant, which can invade into a further microscopic area, or using high wear-resistant lubricant, and a method of reducing the degree of adhesion by applying hardening such as nitriding etc. to the material surface if it is a steel material.

However, in the rolling bearing used for belt-drive continuously variable transmission, a rolling element made of ceramics is difficult to use since it is expensive. Moreover, since the rolling bearings are lubricated with a continuously variable transmission (CVT) fluid used in common for a pulley section and a gear section, any lubricant cannot be optimized for the rolling bearings.

Therefore, the present invention is made in light of such a problem, and its objective is to provide a pulley support structure for a belt-drive continuously variable transmission and a belt-drive continuously variable transmission therewith, which is able to prevent occurrence of Mindlin slip itself, and reduce adverse influences effectively even when Mindlin slip occurs.

### Solution to the Problem

Mindlin slip to be solved by the present invention is one that is occurred due to a small oscillation in an axial direction peculiar to the belt-drive continuously variable transmission.

In order to solve the aforementioned problem, an aspect of the present invention provides the following structure. Namely, a feature of a pulley support structure of a belt-drive continuously variable transmission according to an aspect of the present invention is in that it has a stationary section and a rotation section for rotatably supporting a pulley for continuously variable transmission relative to the stationary section; wherein the rotation section has an input side rotating shaft and an output side rotating shaft arranged in parallel with each other, wherein the input side rotating shaft is rotatably supported relative to the stationary section via a pair of rolling bearings, a driving side pulley whose groove width is expandable and contractable is disposed at a position between the pair of rolling bearings and rotatable in synchronization with the input side rotating shaft as said pulley, the output side rotating shaft is rotatably supported relative to the stationary section via another pair of rolling bearings, a driven side pulley of which groove width is expandable and contractable is disposed at a position between the another pair of rolling bearings and rotatable in synchronization with the output side rotating shaft as said pulley, and an endless belt is laid over the driving side pulley and the driven side pulley. Each of the rolling bearings has an outer wheel and an inner wheel concentrically arranged to each other, wherein the outer wheel has an outer raceway on an inner periphery surface as a raceway surface, and the inner wheel has an inner raceway on an outer peripheral surface as a raceway surface, a plurality of rolling elements is rotatably interposed between the raceway surfaces, and the maximum contact pressure between each of the rolling elements and the raceway surface of the inner wheel and between each of the rolling elements and raceway surface of the outer wheel in use is 2500 MPa or less. Hardness of the raceway surfaces and surfaces of the rolling elements is 60 or greater in HRc, hardness of the surface of each rolling element is HRc harder than 1 in HRc compared with that of the raceway surfaces, the surfaces of the rolling elements are subjected to nitridation or carbonitridation and the nitrogen concentration of the surface is 0.2% by mass or greater and 2.0% by mass or less, and the radial clearance in use is −30 μm or greater and 10 μm or less.

According to an aspect of the pulley support structure of the belt-drive continuously variable transmission of the present invention, since each rolling bearing in use has the maximum contact pressure of 2500 MPa or less between the rolling element and the raceway surface of the inner wheel and between the rolling element and the outer wheel, even if Mindlin slip occurs, expansion of damage due to subsequent additional rotation can be prevented. That is, when the maximum contact pressure between the rolling element and the raceway surface of the inner wheel and between the rolling element and the outer wheel in use is 2500 MPa or less, the rolling elements is avoided rolling on the damaged surface under high pressure, and expansion of the damage is suppressed consequently.

Furthermore, since hardness of the raceway surfaces and the surfaces of the rolling elements is 60 HRc or greater, and hardness of the surface of each rolling element is 1 or more HRc harder than that of the raceway surfaces, surface damage to the rolling elements, which influences significantly, can be suppressed and influence thereof can be reduced effectively.

That is, if a rolling element is damaged due to Mindlin slip, tangential force exerted on the race will then become larger, and damage to the inner wheel and outer wheel due to subsequent additional rotation is liable to occur. Then, hardness of the surface of each rolling element is 1 or more HRc harder than that of the raceway surfaces, arising a hardness difference to the contact members so that damage to the rolling elements is suppressed to the utmost and influence thereof is reduced effectively. Note that the hardness difference between each of the raceway surface and corresponding rolling element is preferably 8 HRc at most. This is because if the hardness difference is too large, damage to the raceway surfaces tends to easily occur even when no Mindlin slip occurs. Moreover, hardness of HRc 60 is required to rotate the rolling bearings with sufficient precision.

Furthermore, since each rolling bearing is subjected to nitridation or carbonitridation beforehand and nitrogen concentration of the surfaces is 0.2% by mass or greater and 2.0% by mass or less, remarkable reduction in occurrence of Mindlin slip particularly on the surfaces of the rolling elements is possible. This prominent effect is obtained when solid solubility of nitrogen is particularly 0.2% by mass or greater and 2.0% by mass or less. When less than 0.2% by mass, a poor result will be obtained, and when it exceeds 2.0% by mass, toughness of the rolling elements will rapidly deteriorate.

Moreover, when a load from a belt is applied on the pulley section, a moment load or a slight axial load will be applied on the rolling bearings. Therefore, an axial load change in load or a vibration will also promote occurrence of Mindlin slip.

Since the radial clearance in each rolling bearing in use is preferably −30 μm or greater and 10 μm or less (more preferably, −20 μm or greater and 0 μm or less, and further more preferably a negative value of −30 μm or greater and −3 μm or less), the occurrence of Mindlin slip due to the axial load change or a vibration in the axial direction is prevented effectively.

That is, since the groove width of the pulley is changed in the belt-drive continuously variable transmission, a misalignment gap between the driving side pulley and the driven side pulley in the axial direction is generated inevitably, resulting inaction an axial force on the rolling bearings in many cases. When the rolling bearings subjected to such an axial force is applied, a vibration from an engine etc., in a state of rest they will induce micro-vibration in the axial direction, resulting in the occurrence of Mindlin slip. Then, when the radial clearance is made negative (negative gap), in other words, an internal stress in each axial is generated in the radial direction, the axial vibration can be reduced. However, if the negative gap exceeds the above-defined range and is too small, rise in the contact pressure will occur, which is not preferable.

Moreover, in the pulley support structure of the belt-drive continuously variable transmission according to another aspect of the present invention, each rolling bearing is a ball bearing for example, and the radius of curvature of the groove in the raceway surface of each of the inner wheel and the outer wheel preferably exceeds 50% of the diameter of the rolling elements and is 52% or less of the same. With such a structure, Mindlin slip in the above-described axial direction can be reduced more effectively.

More specifically, in order to attain such a structure in each rolling bearing, the diameter of each rolling element should be enlarged to be larger than the general JIS (ISO) standard size, and the radius of curvature of the groove in the raceway surface of each of the inner wheel and the outer wheel should exceed 50% of the diameter of the rolling elements and be 52% or less of the same. However, if each rolling bearing is enlarged in its entirety, the belt-drive continuously variable transmission itself becomes larger, which is not preferable.

Enlarging the diameter of each rolling element allows provision of the above-described maximum contact pressure of 2500 MPa favorably. In addition, making the radius of curvature of the groove in the raceway surface of each of the inner wheel and the outer wheel exceed 50% of the diameter of the rolling elements and be 52% or less of the rolling elements improves radial/axial rigidity and moment rigidity, thereby suppressing damage due to Mindlin slip during changes in load effectively.

For example, if the diameter of each rolling element is expanded more than 1.06 times than usual, the pitch circle diameter is increased more than 1.06 times than usual correspondingly thereto, and the radius of curvature of the groove in the raceway surface of each of the inner wheel and the outer wheel is set to exceed 50% the diameter of the rolling elements and be 52% or less of the rolling elements, the radial/axial rigidity and the moment rigidity are improved in addition to the low contact pressure, thereby suppressing the occurrence of Mindlin slip remarkably.

Furthermore, to solve the aforementioned problem, a belt-drive continuously variable transmission according to another aspect of the present invention includes: a stationary section and a rotating section for rotatably supporting a pulley for continuously variable transmission relative to the stationary section; and a pulley support structure for the pulley for continuously variable transmission, which has the pulley support structure for the belt-drive continuously variable transmission according to an aspect of the present invention. Note that it is preferable that the endless belt in the belt-drive continuously variable transmission according to an aspect of the present invention is made of a metal.

According to the belt-drive continuously variable transmission of an aspect of the present invention, the pulley support structure of the belt-drive continuously variable transmission according to an aspect of the present invention suppresses generation of Mindlin slip itself, and adverse influence of Mindlin slip if it occurs will be reduced effectively.

### Advantageous Effect of the Invention

According to the pulley support structure of the belt-drive continuously variable transmission and the belt-drive continuously variable transmission of an aspect of the present invention, the occurrence of Mindlin slip itself is suppressed, and an adverse influence of Mindlin slip if it occurs will be reduced effectively.

### BRIEF DESCRIPTION OF THE DRAWINGS

FIG. 1 is an explanatory drawing showing an outline of a basic structure of a belt-drive continuously variable transmission according to an embodiment of the present invention;

FIG. 2 is a sectional view showing a structure of each rolling bearing of the belt-drive continuously variable transmission according to an embodiment of the present invention;

FIG. 3 is a sectional view explaining how to generate a Mindlin slip in test bearings;

FIG. 4 is a perspective view showing a structure of a testing device for evaluating the performance of the test bearings;

FIG. 5 is a graph illustrating the depths of Mindlin slips occurred in the test bearings;

FIG. 6 is a graph illustrating the maximum contact pressures acted on the test bearings;

FIG. 7 is a graph illustrating the depths of Mindlin slips occurred in the races of the respective test bearings;

FIG. 8 is a graph illustrating the depths of the Mindlin slips occurred in rolling elements of the respective test bearings;

FIG. 9 is a graph illustrating relationships between radial clearance and corresponding depths of Mindlin slips in use; and

FIG. 10 is a graph illustrating radial clearance and corresponding maximum contact pressures acted on respective test bearings during use.

### DESCRIPTION OF EMBODIMENTS

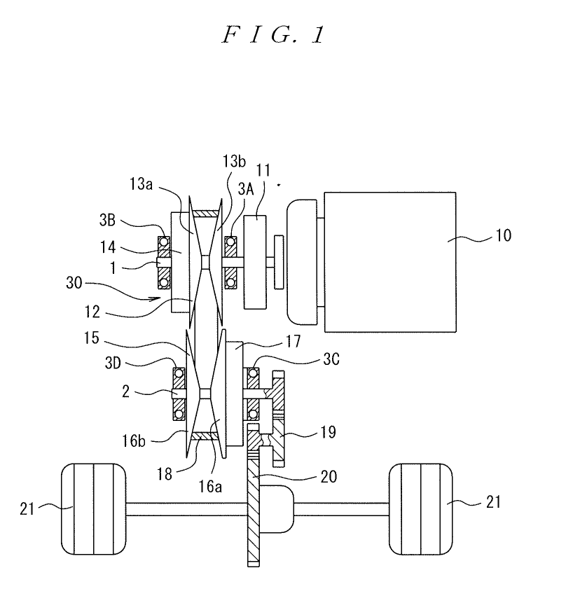

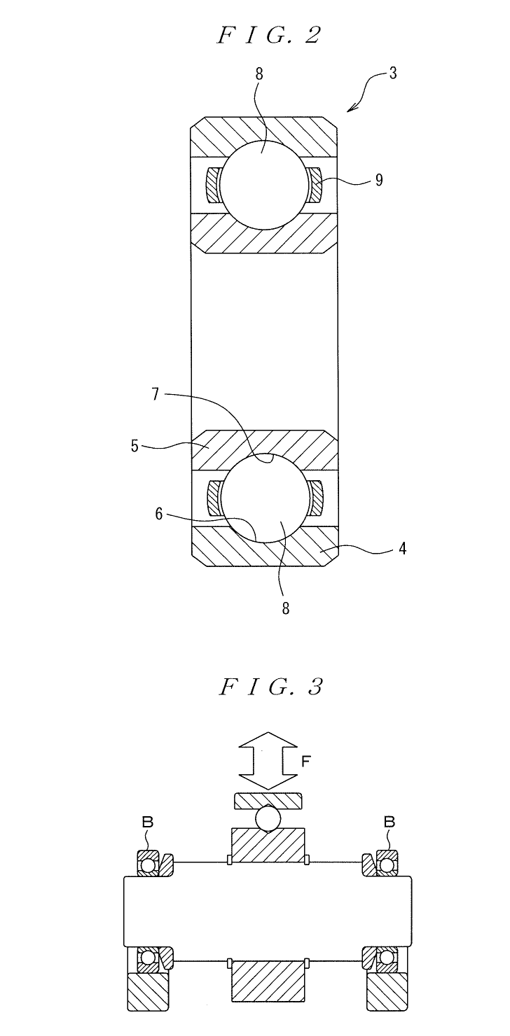

An embodiment of the present invention will now be described with reference to the accompanying drawings. Note that FIG. 1 is an explanatory drawing showing a basic structure of a belt-drive continuously variable transmission. FIG. 2 is a sectional view showing a structure of each rolling bearing for rotatably supporting a pulley for the belt-drive continuously variable transmission.

As shown in FIG. 1, the belt-drive continuously variable transmission includes a rotating section 30, which is arranged inside a transmission case or a stationary section (not shown) and rotatably supports pulleys 12, 15 for stepless transmission. The rotating section 30 has an input side rotating shaft 1 and an output side rotating shaft 2 arranged in parallel with each other. The rotating shafts 1, 2 are rotatably supported in the transmission case via a pair of rolling bearings 3A and 3B and a pair of rolling bearings 3C and 3D, respectively.

As shown in FIG. 2, each of the rolling bearings 3A, 3B, 3C, and 3D has an outer wheel 4 and an inner wheel 5, which are concentrically disposed. The outer wheel 4 has an outer race track 6 as a raceway surface on an inner peripheral surface while the inner wheel 5 has an inner raceway 7 as a raceway surface on an outer peripheral surface. Between the outer raceway 6 and the inner raceway 7, multiple rolling elements 8, 8 are arranged rotatably held by a retainer 9.

The outer wheel 4 of each of the rolling bearing 3A, 3B, 3C, and 3D is internally fitted into and supported by a portion of the transmission case while the inner wheel 5 of each of the rolling bearing is externally fitted onto and supported by the input side revolving shaft 1 or the output side revolving shaft 2. Therefore, each of the rolling bearings 3A, 3B, 3C, and 3D rotatably supports these revolving shafts 1, 2 inside the above-described transmission case.

Each of the rolling bearings 3A, 3B, 3C, and 3D is a deep groove ball bearing (bearing number: 6210) in the example of this embodiment. The surfaces of the outer raceway 6, the inner raceway 7, and the multiple rolling elements 8, 8 are subjected to nitridation or carbonitridation and in nitrogen concentration of the surfaces is 0.2% by mass or greater and 2.0% by mass or less. Furthermore, surface hardness of the outer race track 6, the inner race track 7, and the multiple rolling elements 8, 8 is 60 HRc or harder, and the surface hardness of the rolling elements 8, 8 is harder in 1 or more HRc compared with that of the outer race track 6 and the inner race track 7.

Moreover, each of the rolling bearings 3A and 3B, 3C, and 3D is integrated so that the maximum contact pressure between the outer race track 6 and each of the rolling elements 8, 8 and between the inner race track 7 and each of the rolling elements 8, 8 is 2500 MPa or less in use. Furthermore, the radial clearance of each of the rolling bearings 3A, 3B, 3C, and 3D is −30 μm or greater and 10 μm or less in use. Note that, according to the example of this embodiment, the radius of curvature of the deep groove ball bearing (bearing number 6210) in each of the outer raceway 6 of the outer wheel 4 and the inner raceway 7 of the inner wheel 5 is greater than 50% of the diameter of the rolling elements 8, 8 and 52% or less of the diameter of the rolling elements 8, 8.

As shown in FIG. 1, in the belt-drive continuously variable transmission, the input side rotating shaft 1 of the revolving shafts 1, 2 is rotated by the drive source 10, such as an engine, via a start clutch 11 (e.g., an electromagnetic clutch). Note that a torque converter may be used instead of the start clutch 11. Moreover, a driving side pulley 12 is in the input side rotating shaft 1 disposed at a portion positioned between the pair of rolling bearings 3A and 3B, and the driving side pulley 12 and the input side rotating shaft 1 rotating in synchronization with each other. The gap between a pair of driving side pulley plates 13a and 13b constituting the driving side pulley 12, is adjustable by a driving side actuator 14 by axially displacing the driving side pulley plate 13a (the left one in FIG. 1). Namely, the groove width of the driving side pulley 12 is expandable and contractable by the driving side actuator 14.

Moreover, a driven side pulley 15 is disposed in the output side rotating shaft 2 between the pair of rolling bearings 3C and 3D, and the driven side pulley 15 and the output side rotating shaft 2 rotate in synchronization with each other. The gap between a pair of driven side pulley plates 16a and 16b constituting the passive side pulley 15, is adjustable by a driven side actuator 17 by axially displacing the driven side pulley plate 16a (the right one in FIG. 1). That is, the groove width of the driven side pulley 15 is expandable and contractable by the driven side actuator 17. An endless belt 18 is built between the driven side pulley 15 and the driving side pulley 12. Note that this endless belt 18 is made of a metal.

Motions, operation and effect of the belt-drive continuously variable transmission are described below.

In the belt-drive continuously variable transmission having the above-described configuration, the power transmitted from the drive source 10 to the input side rotating shaft 1 via the start clutch 11 is then transmitted from the driving side pulley 12 to the driven side pulley 15 via the endless belt 18. The power transmitted to the driven side pulley 15 is then transmitted from the output side rotating shaft 2 to driving wheels 21, 21 through a speed reducing gear train 19 and a differential gear 20 (see FIG. 1).

When changing the transmission gear ratio between the input side rotating shaft 1 and the output side rotating shaft 2, the groove widths of the respective pulleys 12, 15 should be expanded and contracted while correlating to each other. For example, the speed reducing ratio between the input side rotating shaft 1 and the output side rotating shaft 2 can be increased by widening the groove width of the driving side pulley 12 as well as narrowing the groove width of the driven side belt pulley 15. As a result, since, at a part of the endless belt 18 laid over the respective pulleys 12, 15, the diameter at the driving side pulley 12 becomes small whereas the diameter at the driven side pulley 15 becomes large, deceleration occurs between the input side rotating shaft 1 and the output side rotating shaft 2.

By contrast, when increasing the speed increasing ratio between the input side rotating shaft 1 and the output side rotating shaft 2, (i.e., decreasing the speed reducing ratio) the groove width of the driving side pulley 12 should be narrowed as well as the groove width of the driven side pulley 15 should be widened. As a result, since, at a part of the endless belt 18 laid over the respective pulleys 12, 15, the diameter at the driving side pulley 12 becomes large whereas the diameter at the driven side pulley 15 becomes small, acceleration occurs between the input side rotating shaft 1 and the output side rotating shaft 2.

Note that during the operation of the belt-drive continuously variable transmission, lubricating oil is supplied to each moving part to lubricate them. Such lubricating oil used for the belt-drive continuously variable transmission is a CVT fluid (Automatic Transmission Fluid: ATF combined oil). The reason why the CVT fluid is used is to increase and stabilize the friction coefficient of frictional engagement sections or the portion between the metallic endless belt 18 and the driving side pulley 12 and portion between the metallic endless belt 18 and the driven side pulley 15. The above-described frictional sections are lubricated by circulating the CVT fluid at a fluid rate of 300 mL/min or greater. Moreover, a part of the CVT fluid passes through the inside of each of the rolling bearings 3A, 3B, 3C, and 3D (e.g., at a fluid rate of 20 mL/min or greater), thereby lubricating a rolling-contact section in each of the rolling bearings 3A, 3B, 3C, and 3D.

Since the maximum contact pressure between the outer raceway 6 of each of the rolling bearings 3A and 3B, 3C, and 3D and each of the corresponding rolling elements 8, 8 and between the inner raceway 7 of each of the same and each of the corresponding rolling elements 8, 8 is set to 2500 MPa or less in use of the belt-drive continuously variable transmission, it is possible to prevent expansion of damage due to subsequent rotation even if Mindlin slip occurs. The inventors of the belt-drive continuously variable transmission according to this invention have found out that the maximum contact pressure is 2500 MPa or less. In this ways, setting maximum contact pressure between the outer raceway 6 and each of the corresponding rolling elements 8, 8 and between the inner raceway 7 and each of the corresponding rolling elements 8, 8 allows effective prevention of expansion of damage due to subsequent rotation even if surface damage, such as Mindlin slip, occurs in a rolling element, as the rolling elements 8, 8 do not roll on the damaged surfaces at high pressure.

Moreover, in each of the rolling bearings 3A, 3B, 3C, and 3D, the surface hardness of the outer race track 6, the inner race track 7, and the rolling elements 8, 8 is set to 60 HRc or harder while surface hardness of the rolling elements 8, 8 is 1 or more HRc harder than that of the outer raceway 6 and the inner raceway 7. This may effectively reduce the surface damage due to Mindlin slip.

Furthermore, since in each of the rolling bearings 3A, 3B, 3C, and 3D, the surfaces of the outer race track 6, the inner race track 7, and the rolling elements 8, 8 are subjected to nitridation or carbonitridation and nitrogen concentration of the surfaces is 0.2% by mass or greater and 2.0% by mass or less, development of Mindlin slip among steel components constituting each of the rolling bearings 3A, 3B, 3C, and 3D can be reduced notably.

Furthermore, since each of the rolling bearings 3A, 3B, 3C, and 3D has a radial clearance of −30 μm or greater and 10 μm or less in use, development of Mindlin slip due to an axial direction vibration can be prevented.

As described above, according to the pulley support structure of a belt-drive continuously variable transmission and the belt-drive continuously variable transmission of the present invention, the occurrence of Mindlin slip itself is suppressed, and an adverse influence of Mindlin slip if it occurs may be reduced effectively.

Note that the pulley support structure of a belt-drive continuously variable transmission and the belt-drive continuously variable transmission according to the present invention are not limited to the above-described embodiment, and various types of modifications thereof are may be made as long as they do not deviate from the spirit of the present invention.

For example, in the above-described embodiment, the example in which the radial clearance (gap) of each of the rolling bearings 3A, 3B, 3C, and 3D in use is −30 μm or greater and 10 μm or less is described. However, the present invention is not limited thereto, and the radial clearance of each of the rolling bearings 3A, 3B, 3C, and 3D in use may be −20 μm or greater and 0 μm or less, for example. This prevents the occurrence of Mindlin slip due to an axial direction vibration.

### Example 1

9 types of test bearings of which nitrogen concentration on the rolling element surface, the radius of curvature of the groove in the raceway surface of each of the inner wheel and the outer wheel etc. differ from one another are prepared, and performance of suppressing a Mindlin slip is evaluated.

First, specification of each test bearing is described. Note that inner wheels, outer wheels, and rolling elements of these 9 types of test bearings are all made of second grade high carbon chromium bearing steels (JIS SUJ2).

A test bearing 1 is a ball bearing of bearing number 6210. The inner wheel, the outer wheel, and the rolling elements are all subjected to bright hardening and annealing as a heat treatment beforehand, and the nitrogen concentration on the raceway of each of the inner wheel and the outer wheel and the surface of each of the rolling elements is 0% by mass. Moreover, the radius of curvature of the groove in the raceway surface of the inner wheel is 50.5% of the diameter of the rolling elements while that of the outer wheel is 53% of the rolling elements. The maximum contact pressure of the test bearing 1 is then adjusted according to these values.

A test bearing 2 is a ball bearing of bearing number 6210. The inner wheel, the outer wheel, and the rolling elements are all subjected to carbonitriding, oil hardening, and annealing as heat treatment beforehand, and the nitrogen concentration on the raceway of each of the inner and outer wheels and the surface of each of the rolling elements is 0.1% by mass. Moreover, the radius of curvature of the groove in the raceway surface of the inner wheel is 50.5% of the diameter of the rolling elements while that of the outer wheel is 53% of the same. The maximum contact pressure of the test bearing 2 is then adjusted according to these values.

A test bearing 3 is a ball bearing of the same specification as that of the test bearing 2. However, the condition for carbonitriding differs therefrom in that the nitrogen concentration on the surface of each of the rolling elements is 0.2% by mass.

A test bearing 4 is a ball bearing of the same specification as that of the test bearing 3, except that the radii of curvature of the groove in the raceway surface of the inner wheel and the outer wheel are 50.5% and 52% of the diameter of the rolling elements, respectively (the diameter of the rolling elements is the same as that of the test bearing 3).

A test bearing 5 is a ball bearing of the same specification as that of the test bearing 3, except that the radii of curvature of the groove in the raceway surface of the inner wheel and the outer wheel are 50.5% and 51.8% of the diameter of the rolling elements, respectively (the diameter of the rolling elements is the same as that of the test bearing 3).

A test bearing 6 is a ball bearing of the same specification as that of the test bearing 1, except that the diameter of the rolling element is 1.06 times that of the test bearing 1, and the radii of curvature of the groove in the raceway surface of the inner wheel and the outer wheel are 50.5% and 52% of the diameter of the rolling elements, respectively.

A test bearing 7 is a ball bearing of the same specification as that of the test bearing 2, except that the diameter of the rolling element is 1.06 times that of the test bearing 2, and the radii of curvature of the groove in the raceway surface of the inner wheel and the outer wheel are 50.5% and 52% of the diameter of the rolling elements, respectively.

A test bearing 8 is a ball bearing of the same specification as that of the test bearing 3, except that the diameter of the rolling element is 1.06 times that of the test bearing 3, and the radii of curvature of the groove in the raceway surface of the inner wheel and the outer wheel are 50.5% and 52% of the diameter of the rolling elements, respectively.

A test bearing 9 is a ball bearing of bearing number 6212. The inner wheel, the outer wheel, and the rolling elements are all subjected to carbonitriding, oil hardening, and annealing as heat treatment beforehand, and the nitrogen concentration on the surface of each of the rolling elements is 0.2% by mass. Moreover, the radii of curvature of the groove in the raceway surface of the inner wheel and the outer wheel are 50.5% and 52% of the diameter of the rolling elements, respectively. The maximum contact pressure of the test bearing 9 is then adjusted according to these values.

An amplitude load is applied on these 9 types of test bearings 1 to 9, causing Mindlin slip on the raceway surfaces of the inner wheel and the outer wheel. That is, as shown in FIG. 3, both ends of the shaft are supported by two test bearings B, and steel balls 10 mm in diameter are disposed on the outer peripheral surface of this shaft. A servo pulsar (not shown) is used to apply one million cycles of a radial amplitude load F, which change periodically between 12000 N and 15000 N on the steel balls. Note that the frequency of the amplitude load F is 50 Hz. The depth (wear loss) of the Mindlin slip occurred in such a way as described above on the raceway surface of each of the inner wheel and the outer wheel is measured.

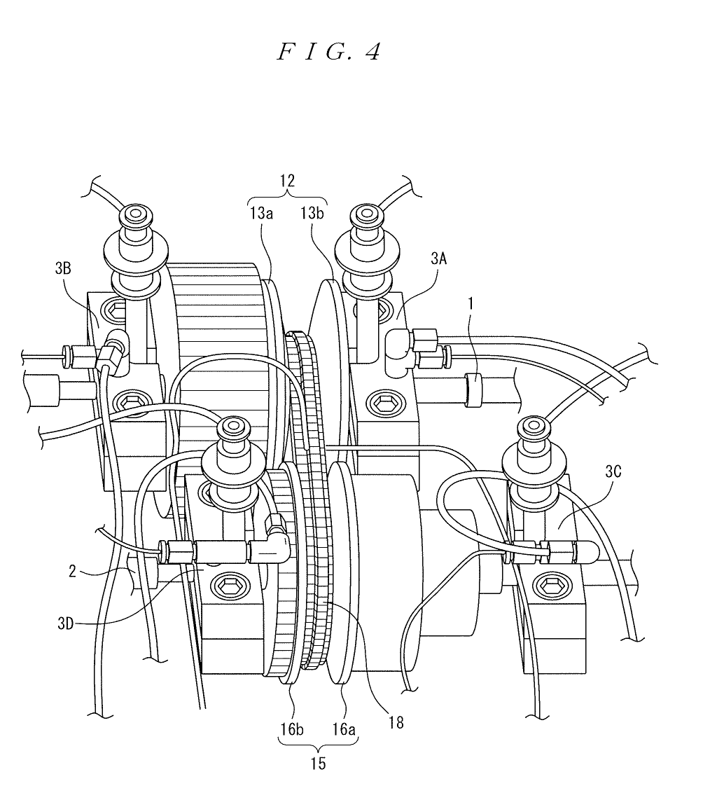

Next, the performance of each of the test bearings 1 to 9 in which a Mindlin slip has occurred in the way described above is evaluated. A testing device of FIG. 4, which is fabricated by taking out the endless belt and the pulley support section from the belt-drive continuously variable transmission, is used for performance evaluation. Since the structure of this testing device is the same as the pulley support section of the belt-drive continuously variable transmission of FIG. 1, description thereof is omitted. Note that in FIG. 4, the same reference numerals as those in FIG. 1 are given to the equivalent or corresponding portions.

The above-described test bearings are incorporated into the testing device of FIG. 4. That is, the above-described test bearings are used as the rolling bearing 3A, which supports the input side rotating shaft 1 in the testing device of FIG. 4. A dynamo capable of outputting a torque of 300 Nm is used as a drive source to operate this testing device. At this time, a pulley ratio is changed between 0.5 and 2.0 so as to repetitively change the transmission gear ratio between the input side rotating shaft 1 and the output side rotating shaft 2 to 2000 rpm/sec for acceleration and to 500 rpm/sec for deceleration.

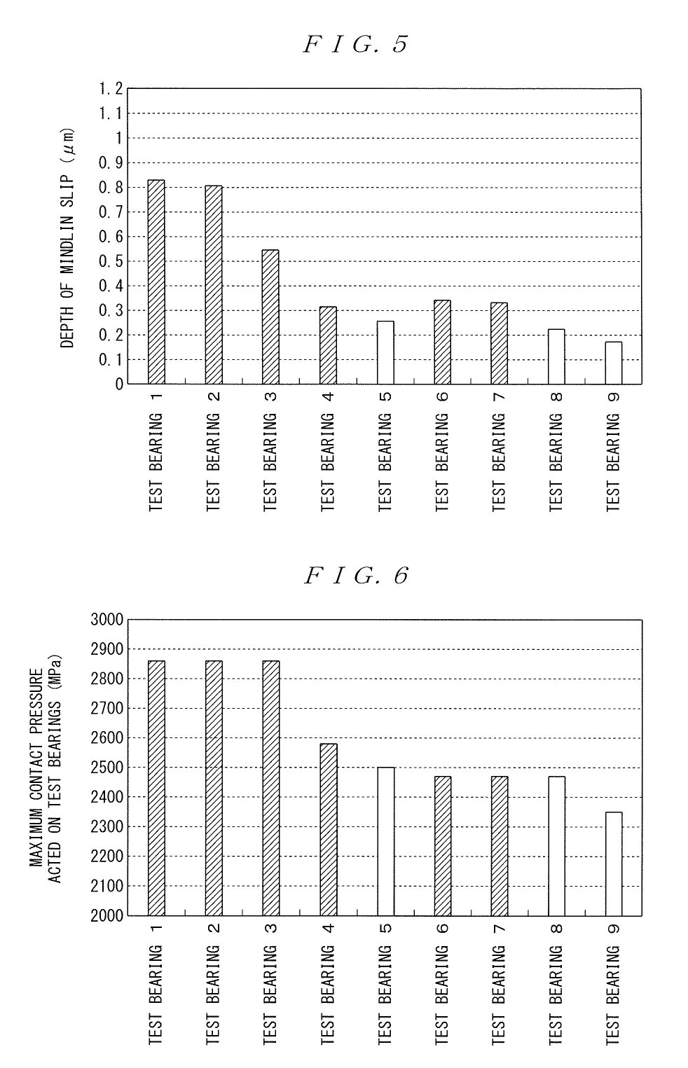

First, the depth of Mindlin slip occurred on the raceway surface of each of the test bearings 1 to 9 is given in Table 1 and FIG. 5, and the maximum contact pressure applied on each of the test bearings 1 to 9 during operation of the above-described testing device is given in Table 1 and FIG. 6.

TABLE 1

| | Specification of | | | | |
|---|---|---|---|---|---|
| | test bearing | | | | Exis- |
| | Radius of | Nitrogen | Depth | Maxi- | tence |
| | curvature: | concentration | of | mum | of |
| | inner wheel/ | rolling | Mindlin | contact | break- |
| | outer wheel | element | slip | pressure | age |
| Test | 50.5%/53% | 0% by mass | 0.83 μm | 2860 MPa | Yes |
| bearing 1 | | | | | |
| Test | 50.5%/53% | 0.1% by mass | 0.81 μm | 2860 MPa | Yes |
| bearing 2 | | | | | |
| Test | 50.5%/53% | 0.2% by mass | 0.55 μm | 2860 MPa | Yes |
| bearing 3 | | | | | |
| Test | 50.5%/52% | 0.2% by mass | 0.32 μm | 2580 MPa | Yes |
| bearing 4 | | | | | |
| Test | 50.5%/51.8% | 0.2% by mass | 0.26 μm | 2500 MPa | No |
| bearing 5 | | | | | |
| Test | 50.5%/52% | 0% by mass | 0.34 μm | 2470 MPa | Yes |
| bearing 6 | | | | | |
| Test | 50.5%/52% | 0.1% by mass | 0.33 μm | 2470 MPa | Yes |
| bearing 7 | | | | | |
| Test | 50.5%/52% | 0.2% by mass | 0.22 μm | 2470 MPa | No |
| bearing 8 | | | | | |
| Test | 50.5%/52% | 0.2% by mass | 0.17 μm | 2350 MPa | No |
| bearing 9 | | | | | |

Table 1 and FIGS. 5 and 6 show that the higher the nitrogen concentration on the surface of each rolling element, the depth of the Mindlin slip became smaller in the test bearings 1 to 4. Moreover, it also apparent that the smaller the radius of curvature of the groove in the raceway surface of each of the inner wheel and the outer wheel, the depth of the Mindlin slip became shallower. However, since the maximum contact pressure exceeds 2500 MPa, the test bearings 1 to 3 were all damaged before the operation time has reached a rated theoretical life of each test bearing. Moreover, the test bearing 4 could continue to operate until the rated theoretical life. However, minute flaking was observed on the raceway surface of the outer wheel through decomposition examination after termination of the operation.

The test bearing 5 where the maximum contact pressure is adjusted by changing the radius of curvature of the groove in the raceway surface of test bearing 4 to 2500 MPa is then tested. As a result, although the operation time has reached the rated theoretical life, no flaking was observed on either the raceway surface or the surfaces of the rolling elements, and further continuous operation was possible.

However, the test bearing 6 was damaged before the operation time reaches the rated theoretical life since the nitrogen concentration on the surfaces of the rolling elements is 0% by mass even though the maximum contact pressure is 2500 MPa or less. In the test bearing 7, minute flaking was observed on the raceway surface of the outer wheel and the surfaces of the rolling elements through disassembly examination after termination of the operation since the nitrogen concentration on the surfaces of the rolling elements is 0.1% by mass, which was insufficient, even though the maximum contact pressure is 2500 MPa or less and the operation could continue until the rated theoretical life.

On the other hand, it is observed that the depth of the Mindlin slip in the test bearing 8 was smaller than that of each of test bearings 6 and 7 since the nitrogen concentration on the surfaces of the rolling elements is 0.2% by mass. The operation time reaches the rated theoretical life, no flaking is observed on the surfaces of the rolling elements, and further continuous operation was possible.

These results indicate that influences of Mindlin slip can be suppressed by setting the nitrogen concentration on the surfaces of the rolling elements to 0.2% by mass even though the maximum contact pressure of the test bearing 8 is the same as that of each of the test bearings 6 and 7.

Therefore, it is understood that the greater the depth of the Mindlin slip, the greater the influence of tangential force generated due to contact between the raceway surface of the inner wheel and the damaged rolling element and also due to contact between the raceway surface of the outer wheel and the damaged rolling element, influencing the bearing life. Then, the radius of curvature of the groove on the raceway surface of each of the inner wheel and the outer wheel is reduced so that the rate of change of the diameter of the contact ellipse at the time of change in load is reduced. Furthermore, they are carbonitrided or nitrided beforehand so that influence of the Mindlin slip between the steel components is suppressed and that damage to the rolling elements and the raceway surface is made smaller, thereby improving the bearing life.

As described above, it is observed that the nitrogen concentration on the surface of the rolling element influences reduction in Mindlin slip, and it is also known that toughness (fracture toughness) will decrease if the nitrogen concentration is too high. Therefore, influence of the decreased toughness should be taken into account for design of the rolling bearing used for transmission which is affected by an impact load such as a stall etc.

As to the influence of the decreased toughness, the aforementioned Patent Document 4 (JP 2009-41744A) titled “Relationship between surface nitrogen concentration and absorbed energy” indicates that the higher the nitrogen concentration, the lower the impact strength of the rolling element due to influence of that toughness. Moreover, it is understood that the impact strength will fall rapidly if the nitrogen concentration exceeds 2.0% by mass. Therefore, the nitrogen concentration on the surface of the rolling element for the rolling bearing, which is incorporated into the pulley support structure of the belt-drive continuously variable transmission, is required to be 0.2% by mass or greater. However, according to the above-described well-known document, it should be 2.0% by mass or less.

By expanding the diameter of the rolling element so as to set the maximum contact pressure to 2500 MPa or less after the above-described conditions are satisfied, even if Mindlin slip occurs, damage to the raceway surfaces of the inner wheel and the outer wheel and the rolling elements can be reduced effectively. As a result, early flaking of the rolling bearing incorporated into the pulley support structure of the belt-drive continuously variable transmission can be prevented.

### Example 2

In Example 1, the surface hardness of the rolling element was equivalent to that of the raceway surfaces of the inner wheel and the outer wheel. Meanwhile, in Example 2, influences due to different hardness thereof are tested. Test bearings, each having a different surface hardness of the rolling element and different hardness of the raceway surface of each of the inner wheel and the outer wheel, are prepared by modifying the test bearing 5, and the same performance evaluation as that for Working Example 1 is carried out.

Hardness of respective raceway surfaces of the inner wheel and the outer wheel in the test bearings 5A to 5L used for this test is 58.0, 59.0, 60.0, or 61.0 HRc, respectively. Moreover, surface hardness of the rolling element is −1 HRc, equal HRc, or +1 HRc of the hardness of the above-described raceway surface (see Table 2).

TABLE 2

| | Hardness | | Depth of Mindlin | | |
|---|---|---|---|---|---|
| | (HRc) | | slip | | Existence |
| | | Rolling | | Rolling | of |
| | Race | element | Race | element | breakage |
| Test bearing 5A | 58.0 | 57.0 | 0.46 μm | 0.25 μm | Yes |
| Test bearing 5B | 58.0 | 58.0 | 0.48 μm | 0.23 μm | Yes |
| Test bearing 5C | 58.0 | 59.0 | 0.50 μm | 0.21 μm | Yes |
| Test bearing 5D | 59.0 | 58.0 | 0.44 μm | 0.24 μm | Yes |
| Test bearing 5E | 59.0 | 59.0 | 0.46 μm | 0.22 μm | Yes |
| Test bearing 5F | 59.0 | 60.0 | 0.47 μm | 0.20 μm | Yes |
| Test bearing 5G | 60.0 | 59.0 | 0.41 μm | 0.23 μm | Yes |
| Test bearing 5H | 60.0 | 60.0 | 0.42 μm | 0.21 μm | Yes |
| Test bearing 5I | 60.0 | 61.0 | 0.43 μm | 0.18 μm | No |
| Test bearing 5J | 61.0 | 60.0 | 0.40 μm | 0.23 μm | Yes |
| Test bearing 5K | 61.0 | 61.0 | 0.41 μm | 0.20 μm | Yes |
| Test bearing 5L | 61.0 | 62.0 | 0.42 μm | 0.13 μm | No |

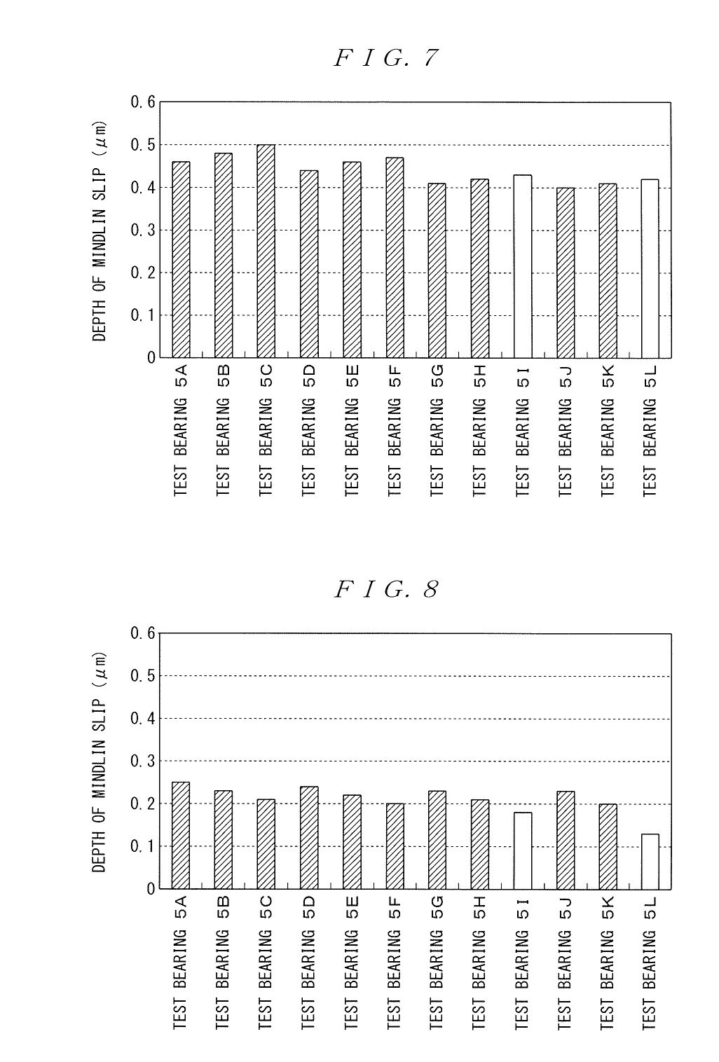

Depth of the Mindlin slip is measured for the test bearings 5A to 5L in the same way as in Example 1. Table 2 and FIG. 7 show the measured depth of the Mindlin slip occurred on each of the raceway surfaces of the respective test bearings 5A to 5L while Table 2 and FIG. 8 show the measured depth of the Mindlin slip occurred on each of the surfaces of the rolling elements in the respective test bearings 5A to 5L. Moreover, performance of each of the test bearings 5A to 5L is evaluated using the testing apparatus shown in FIG. 4 in the same way as in Example 1. The results therefrom are given in Table 2.

Table 2 and FIGS. 7 and 8 show that the greater the hardness of the raceway surface and the surface of the rolling element, the depth of Mindlin slip became smaller. However, although the test bearings 5A to 5G, which have hardness of the raceway surface or hardness of the surface of the rolling element less than 60 HRc, and the test bearings 5H, 5J, and 5K, in which hardness of the raceway surface and hardness of the surface of the rolling element is 60 HRc or harder but the hardness of the surface of the rolling element is equal to or less than that of the raceway surface, could continue to operate until the rated theoretical life of each test bearing, flaking or minute damage to the raceway surface of the outer wheel was observed through disassembly examination after termination of the operation. This is understood to be attributable to the raceway surface or the surface of the rolling element affected by the Mindlin slip, influencing the bearing life.

In the case of the rolling element in particular, when it is damaged due to the Mindlin slip, the expansion degree of the damage due to additional subsequent rotation tends to be larger than that of the inner wheel and the outer wheel. Moreover, the damaged surface of the rolling element increases the tangential force along the contact surface with the raceway surface, greatly influencing the life of the raceway surfaces of the outer wheel and the inner wheel.

On the other hand, operation time of the test bearings 5I and 5L, in which hardness of the raceway surface and the surface of the rolling element is 60 HRc or harder and the hardness of the surface of the rolling element is equal to or greater than hardness of the raceway surface, has reached the rated theoretical life, no flaking has been observed on the surface of the rolling element etc., and the test bearings 5I and 5L could further continue to operate.

As is apparent from these results, setting the surface of each rolling element to be 1 HRc harder than the raceway surface causes less damage to the surface of the rolling element due to Mindlin slip, and prevents the influence of the tangential force, thereby improving the life of the raceway surface of the rolling bearing. This requires the hardness of the surface of the rolling element in the rolling bearing incorporated into the pulley support structure for the belt-drive continuously variable transmission to be harder HRc than hardness of the raceway surfaces of the inner wheel and the outer wheel, so as to reduce the damage to the rolling element.

### Example 3

In Examples 1 and 2, in order to observe the effect and hardness of the radius of curvature of the groove in the raceway surfaces of the inner wheel and the outer wheel, the radial clearance of each of the test bearings 1 to 9 and 5A to 5L incorporated into the testing device of FIG. 4 is set to +5 μm. In Example 3, in order to observe the influence of the radial clearance, the following test bearings are prepared, and the same performance evaluation as that in Examples 1 and 2 is carried out.

9 types of test bearings 11 to 19 are prepared by modifying the dimension of the test bearing 5I such that the radial clearance in use is a predetermined value. These test bearings 11 to 19 differ from one another only in the radial clearance contractable, and all other specifications, such as radius of curvature of the groove, heat treatment conditions, and hardness, are the same.

TABLE 3

| | | | | Maximum |
|---|---|---|---|---|
| | Radial | | Depth of | contact |
| | clearance | | Mindlin slip | pressure |
| Test bearing 11 | −0.035 | μm | 0.14 μm | 2550 MPa |
| Test bearing 12 | −0.03 | μm | 0.15 μm | 2530 MPa |
| Test bearing 13 | −0.02 | μm | 0.18 μm | 2500 MPa |
| Test bearing 14 | −0.01 | μm | 0.21 μm | 2480 MPa |
| Test bearing 15 | 0 | μm | 0.24 μm | 2470 MPa |
| Test bearing 16 | 0.005 | μm | 0.26 μm | 2470 MPa |
| Test bearing 17 | 0.01 | μm | 0.27 μm | 2470 MPa |
| Test bearing 18 | 0.015 | μm | 0.29 μm | 2480 MPa |
| Test bearing 19 | 0.025 | μm | 0.32 μm | 2490 MPa |

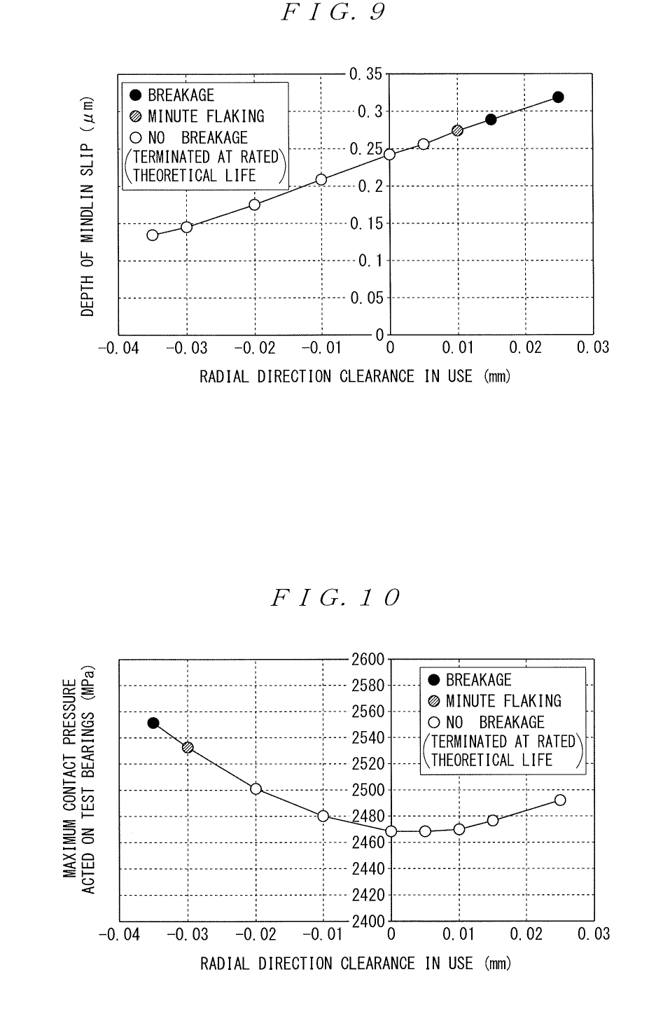

Depth of the Mindlin slip is measured for these test bearings 11 to 19 in the same way as in Example 1. Moreover, performance of each of the test bearings 11 to 19 is evaluated in the same way as in Example 1 using the testing device shown in FIG. 4. Table 3 and FIG. 9 show the measured depths of the Mindlin slips occurred on the raceway surfaces of the test bearings 11 to 19 while Table 3 and FIG. 10 show the maximum contact pressure applied on each of the test bearings 11 to 19 during the operation of the above-described testing device.

FIG. 9 shows that the larger the radial clearance, the larger the depth of Mindlin slip, and the larger the negative clearance, the depth of Mindlin slip became smaller. According to an actual evaluation using the testing device of FIG. 4, the test bearings were damaged when the radial clearance is equal to or greater than +10 μm.

However, with the testing device of FIG. 4, only the radial load given only by the belt tension is exerted on the test bearings. However, in the case of the bearings incorporated into the pulley support structure of the actual belt-drive continuously variable transmission, an axial load may be applied on the rolling bearings. Therefore, the same performance evaluation is performed even in a case where an axial load (preload) is applied beforehand on the test bearings so as to make the maximum contact pressure match the same loading condition for the testing device of FIG. 4.

FIG. 10 shows that the maximum contact pressure increases when the negative clearance is too small on the negative gap side where the depth of Mindlin slip is smaller under the condition an axial load is applied. When the clearance is −30 μm or less, the maximum contact pressure exceeds 2500 MPa. Therefore, each test bearing could continue to operate until the rated theoretical life. However, flaking or minute damage to the raceway surface of the outer wheel was observed through disassembly examination after termination of the operation.

Thus, setting the radial clearance of the rolling bearing to a negative clearance allows reduction of vibration occurring in the axial direction and further reduction in Mindlin slip. On the other hand, the maximum contact pressure increases in the region on which the axial load is applied. When the maximum contact pressure exceeds 2500 MPa, it influences the bearing life.

Therefore, it is preferable to assume both reduction in influence of Mindlin slip and rise in the maximum contact pressure for the rolling bearing incorporated into the pulley support structure of the belt-drive continuously variable transmission in light of the case where an axial load is applied. That is, as shown in FIG. 10, the radial clearance (radial direction clearance) is preferably −30 μm or greater and 10 μm or less, more preferably −20 μm or greater and 0 μm or less, at which no breakage of each test bearing has been observed.

### REFERENCE SIGNS LIST

1, 2: rotating shaft
3A to 3D: rolling bearing
4: outer wheel
5: inner wheel
6: outer raceway (Raceway surface)
7: inner raceway (Raceway surface)
8: rolling element
9: retainer
10: drive source
11: start clutch
12: driving side pulley (pulley)
15: driven side pulley (pulley)
30: Rotating section

1. A pulley support structure for a belt-drive continuously variable transmission, comprising:
a stationary section and a rotary section for rotatably supporting a pulley for continuously variable transmission relative to the stationary section; wherein
the rotating section has an input side revolving shaft and an output side revolving shaft arranged in parallel with each other, wherein the input side revolving shaft is rotatably supported relative to the stationary section via a pair of rolling bearings, a driving side pulley whose groove width is expandable and contractable is disposed at a position between the pair of rolling bearings as the pulley and the driving side pulley is rotatable in synchronization with the input side rotating shaft, the output side rotating shaft is rotatably supported relative to the stationary section via another pair of rolling bearings, a driven side pulley of which groove width is expandable and contractable is disposed at a position between the another pair of rolling bearings as the pulley and the driven side pulley is rotatable in synchronization with the output side revolving shaft, and an endless belt is laid over the driving side pulley and the driven side pulley,
each of the rolling bearings has an outer wheel and an inner wheel concentrically arranged to each other, wherein
the outer wheel has an outer raceway on an inner periphery surface as a raceway surface, the inner wheel has an inner raceway on an outer peripheral surface as a raceway surface, a plurality of rolling elements are rotatably interpose between the raceway surfaces, and the maximum contact pressure between each of the rolling elements and the raceway surface of the inner wheel and between each of the rolling elements and raceway surface of the outer wheel during use is 2500 MPa or less,
hardness of the raceway surfaces and surfaces of the rolling elements is HRc 60 or greater, and hardness of the surface of each rolling element is harder than 1 in HRc compared with that of the raceway surfaces,
at least the surfaces of the rolling elements are subjected to nitridation or carbonitridation and the surfaces of nitrogen concentration is set to 0.2% by mass or greater and 2.0% by mass or less, and
a radial clearance in use is −30 μm or greater and 10 μm or less.

2. The pulley support structure for the belt-drive continuously variable transmission according to claim 1, wherein each of the rolling bearings in use has a radial clearance of −20 μm or greater and 0 μm or less.

3. The pulley support structure for the belt-drive continuously variable transmission according to claim 1, wherein each of the rolling bearings is a ball bearing, and a radius of curvature of the groove in each of the raceway surfaces of the inner wheel and the outer wheel exceeds 50% of the diameter of the rolling elements and is 52% or less of the same.

4. A belt-drive continuously variable transmission comprising a stationary section and a rotary section for rotatably supporting a pulley for continuously variable transmission relative to the stationary section, wherein belt-drive continuously variable transmission has a pulley support structure for the pulley for continuously variable transmission according to claim 1 as the pulley support structure for the belt-drive continuously variable transmission.

5. The belt-drive continuously variable transmission according to claim 4, wherein the endless belt is made of a metal.

6. The pulley support structure for the belt-drive continuously variable transmission according to claim 1, wherein each of the rolling bearings is a ball bearing, and a radius of curvature of the groove in each of the raceway surfaces of the inner wheel and the outer wheel exceeds 50% of the diameter of the rolling elements and is 52% or less of the same.

7. A belt-drive continuously variable transmission comprising a stationary section and a rotary section for rotatably supporting a pulley for continuously variable transmission relative to the stationary section, wherein belt-drive continuously variable transmission has a pulley support structure for the pulley for continuously variable transmission according to claim 2 as the pulley support structure for the belt-drive continuously variable transmission.

8. A belt-drive continuously variable transmission comprising a stationary section and a rotary section for rotatably supporting a pulley for continuously variable transmission relative to the stationary section, wherein belt-drive continuously variable transmission has a pulley support structure for the pulley for continuously variable transmission according to claim 3 as the pulley support structure for the belt-drive continuously variable transmission.

9. A belt-drive continuously variable transmission comprising a stationary section and a rotary section for rotatably supporting a pulley for continuously variable transmission relative to the stationary section, wherein belt-drive continuously variable transmission has a pulley support structure for the pulley for continuously variable transmission according to claim 6 as the pulley support structure for the belt-drive continuously variable transmission.
